(19) United States
(12) Patent Application Publication
(10) Pub. No.: US 2011/0241876 A1
(43) Pub. Date: Oct. 6, 2011

(54) INDICIA READER WITH DIRTY WINDOW INDICATOR

(75) Inventor: Sean Philip Kearney, Marlton, NJ (US)

(73) Assignee: Metrologic Instruments, Inc., Blackwood, NJ (US)

(21) Appl. No.: 12/755,091

(22) Filed: Apr. 6, 2010

(51) Int. Cl. G08B 21/00

(52) U.S. Cl. 340/540

(57) ABSTRACT

A method of operating an indicia reader comprising the steps of: transmitting light partly through a window toward a target; receiving reflected light from a target and the window onto a photodetector; converting the received light into photodetector output signals representative thereof with the photodetector; storing a baseline photodetector photodetector output signal derived solely from light reflected from the window; decoding indicia information within the target containing information bearing indicia derived from the photodetector output signals; comparing photodetector output signals with the baseline photodetector output signal; and, notifying an operator with an audible or visual signal when the comparison indicates the window is contaminated.

### FIELD OF THE INVENTION

The present invention relates to indicia reading devices, and more particularly to an indicia reader having a dirty window indicator.

### BACKGROUND

Indicia reading devices (also referred to as scanners, image reader, indicia readers, etc.) typically read data represented by printed or displayed information bearing indicia (IBI), (also referred to as symbols, symbology, bar codes, etc.) For instance one type of a symbol is an array of rectangular bars and spaces that are arranged in a specific way to represent elements of data in machine readable form. Indicia reading devices typically transmit light onto a symbol and receive light scattered and/or reflected back from a bar code symbol or indicia. The received light is interpreted by a processor which performs signal and/or image processing to extract the data represented by the symbol. Indicia reading devices typically utilize visible or infrared light. Laser indicia reading devices typically utilize transmitted laser light.

One-dimensional (1D) indicia readers are characterized by reading data that is encoded along a single axis, in the widths of bars and spaces, so that such symbols may be read from a single scan along that axis, provided that the symbol is sampled with a sufficiently high resolution along that axis.

In order to allow the encoding of larger amounts of data in a single bar code symbol, a number of 1D stacked bar code symbologies have been developed which partition encoded data into multiple rows, each including a respective 1D bar code pattern, some or all of which must be scanned and decoded, then linked together to form a complete message. Scanning still requires relatively higher resolution in one dimension only, but multiple linear scans at different locations on a second dimension are needed to read the whole symbol.

A class of bar code symbologies known as two dimensional (2D) matrix symbologies have been developed which require image based reading and offer greater data densities and capacities than 1D symbologies. 2D matrix codes encode data as dark or light data elements within a regular polygonal matrix, accompanied by graphical finder, orientation and reference structures.

Often times an indicia reader may be portable and wireless in nature thereby providing added flexibility. In these circumstances, such readers form part of a wireless network in which data collected within the terminals is communicated to a host computer situated on a hardwired backbone via a wireless link. For example, the readers may include a radio or transceiver for communicating with a remote computer.

Some data collection devices, such as hand-held indicia readers, are capable of capturing images as well as reading barcodes. The reading and decoding of a barcode represents an operation distinct from that involved in capturing an image. The reading and decoding of a bar code involves the imaging and then decoding of a one or two dimensional graphic symbol into the alphanumeric, full ASCII or other data sequence encoded by the symbol. The capturing of an image involves storing an electronic visual copy/representation of the image.

Efforts regarding such systems have led to continuing developments to improve their versatility, practicality and efficiency.

### BRIEF DESCRIPTION OF THE DRAWINGS

FIG. 1 is a block diagram of an exemplary indicia reader system.

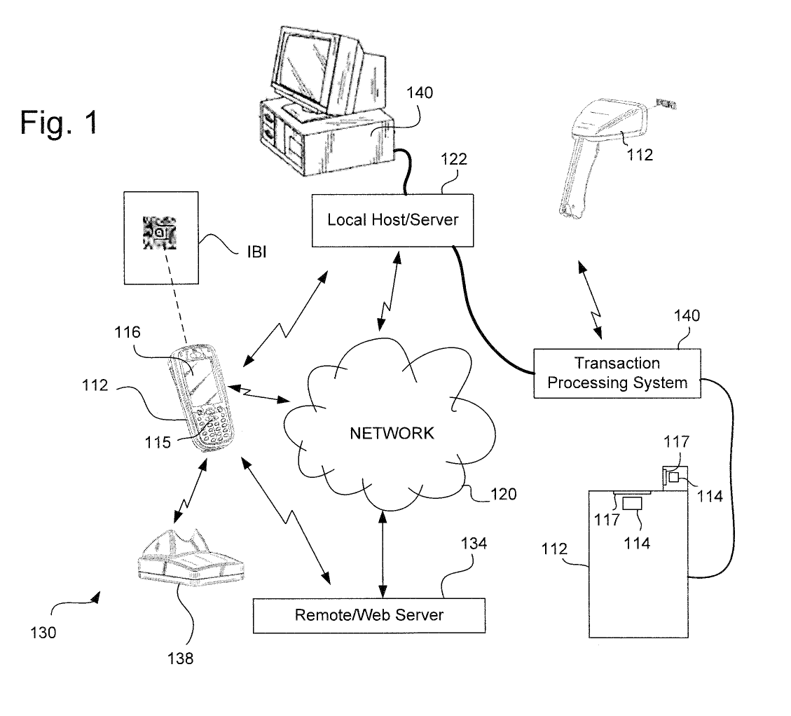

FIG. 2 is a block schematic diagram of an exemplary indicia reader.

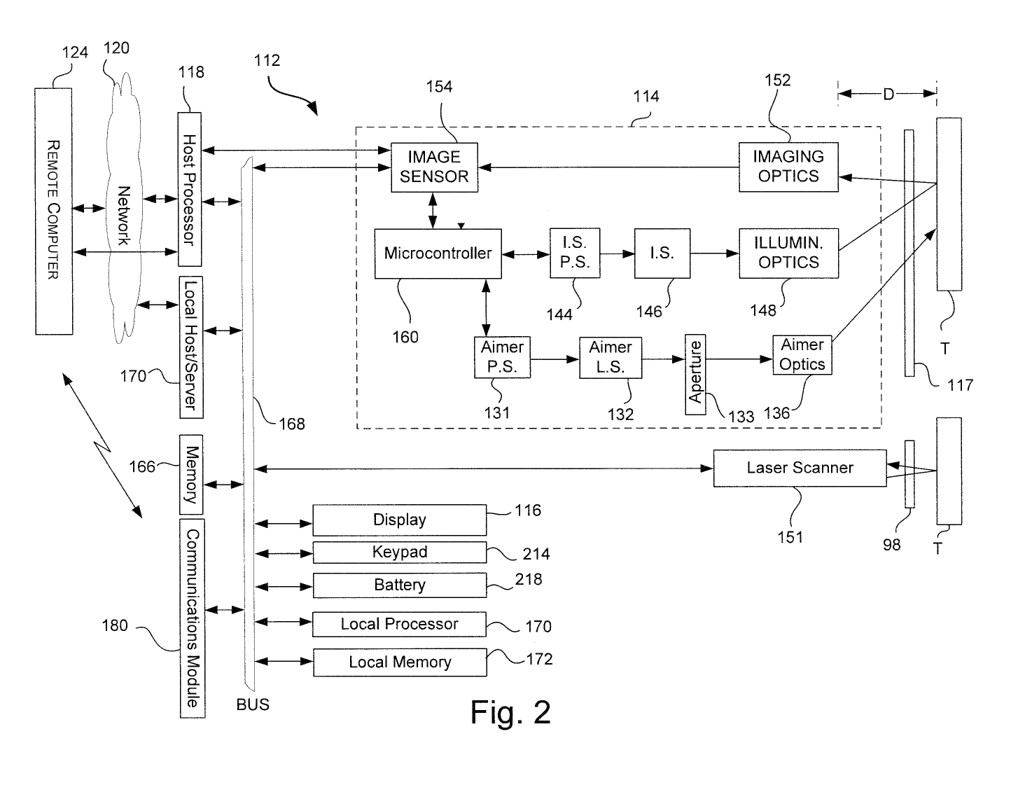

FIG. 3 is a fragmentary partially cutaway side view of an exemplary indicia reader.

FIG. 4 is a fragmentary partially cutaway side view of an exemplary indicia reader.

FIG. 5 is a flowchart of an exemplary process for operating an indicia reader.

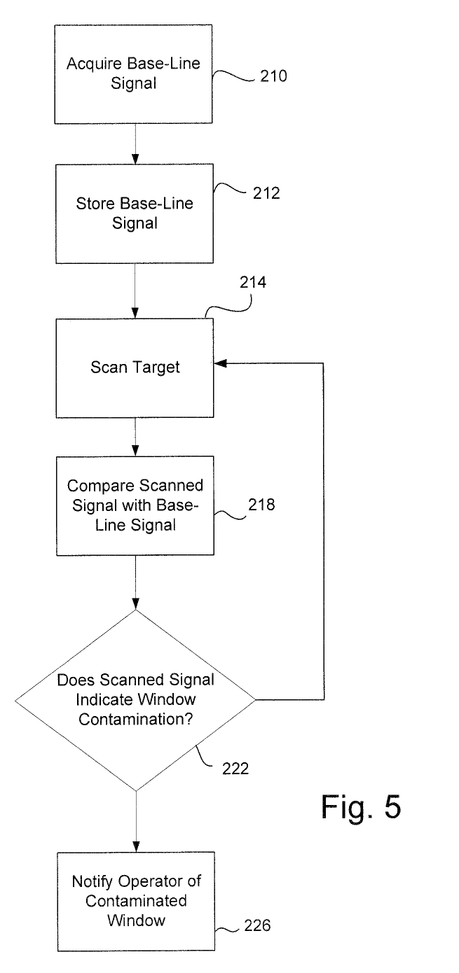

FIG. 6 is a flowchart of an exemplary process for operating an indicia reader.

### DETAILED DESCRIPTION

Reference will now be made to exemplary embodiments which are illustrated in the accompanying drawings. Other embodiments may be in various forms and the exemplary embodiments should not be construed as limited to the embodiments set forth herein. Rather, these representative embodiments are described in detail so that this disclosure will be thorough and complete, and will fully convey the scope, structure, operation, functionality, and potential applicability to those skilled in the art. Wherever possible, the same reference numbers will be used throughout the drawings to refer to the same or like parts. The term “scan” or “scanning” used herein refers to reading or extracting data from an information bearing indicia (or symbol). The term imaging used herein refers to the taking or creation of an electronic image.

The Figures illustrate an exemplary scanning system configuration, wherein a plurality of indicia readers 112 are being operated according to an embodiment of the present invention and utilized where information bearing indicia (IBI) are present. The indicia readers may be stationary or hand-held and may be either laser indicia reading devices (or laser scanners) utilizing transmitted laser light or optical indicia reading devices utilizing image capturing. The indicia readers 112 have indicia reading assemblies 114 for extracting data from IBIs. The indicia reading assemblies 114 are protected by windows 117.

A human operator may aim a hand-held indicia reader 112 at a target containing an IBI or dataform, text, or other element and actuate a trigger 115 on the indicia reader. An IBI or dataform may be an originally machine generated symbology that is also machine readable, such as a 1-D barcode, a 2-D barcode, a 1-D stacked barcode, a logo, glyphs, color-codes, and the like.

When using an embodiment of an indicia reader, a human operator may intuitively point the indicia reader directly at the data to be collected, regardless of its type, and actuate a trigger.

An exemplary indicia reader 112 may employ a laser scanning reader 151 for reading indicia on a target T that transmits and receive light through a window 98.

An exemplary indicia reader 112 may be a mobile device, such as a hand held scanner, a portable data terminal (PDT), personal digital assistant (PDA), mobile phone, etc. A Portable Data Terminal, or PDT, is typically an electronic device that is used to enter or retrieve data via wireless transmission (WLAN or WWAN) and may also serve as an indicia reader used in stores, warehouse, hospital, or in the field to access a database from a remote location. Personal Digital Assistants (PDAs) are handheld devices typically used as a personal organizer, and may have many uses such as calculating, use as a clock and calendar, playing computer games, accessing the Internet, sending and receiving E-mails, use as a radio or stereo, video recording, recording notes, use as an address book, and use as a spreadsheet. The indicia reader may have a display 116. An exemplary indicia reader has an image sensor or photodetector which digitizes a representative image seen in an imaging field of view. The indicia readers may be in communication (wired or wireless) to a local transaction processing system 140, such as a cash register, customer station or employee station. The transaction processing systems 140 may be at a point of transaction (POT) or sale and may be in communication (wired or wireless) with a local server 122. The local server 122 may be in communication with network 120 and or a remote/web server 134.

An exemplary indicia reader 112 which may have a number of subsystems for capturing and reading images, some of which may have symbol indicia provided therein. Reader 112 may have an imaging reader assembly 114 (including an image sensor 154) provided within a head portion or housing 17 which may be configured to be hand held by a handle portion 111. A trigger 115 may be used to control operation of the reader 112. The head portion of a housing 113 may have a medial plane MP selected so that when the hand-held imager is held with the head portion generally in a horizontal plane, the medial plane MP will generally be perpendicular to the face of the head portion of the scanning housing 113. Generally operators have a tendency to hold the medial plane of the head portion of the imager approximately normal to the plane of the target when collecting data. Image reader assembly 114 has imaging reader imaging optics having an optical axis (OA) for receiving light reflected off of a target T. The optical axis is a line of symmetry through the imaging optics. The target may be any object or substrate which may bear a 1D or 2D bar code symbol or text or other machine readable indicia.

A trigger 115 may be used for controlling full or partial operation of the reader 112. Imaging reader assembly 114 may also have an aiming generator light source 132, aiming aperture 133, aiming optics 136, an illumination source 146, illumination optics 148 and imaging optics 152.

Illumination and aiming light sources with different colors may be utilized. For example, in one such embodiment the image reader may include white and red LEDs, red and green LEDs, white, red, and green LEDs, or some other combination chosen in response to, for example, the color of the symbols most commonly imaged by the image reader. Different colored LEDs may be each alternatively pulsed at a level in accordance with an overall power budget.

An exemplary indicia reading system 110 may include a reader 112 in communication with a host processor 118. This host processor may be in communication with a network 120 which may be connected to one or more network computers 124. Reader 112 may include a number of components, such as an aiming pattern generator 130 adapted to generate an aiming pattern for assisting an operator to align target T coincident with the field of view of an imaging subassembly 150.

Aiming pattern generator 130 may include a power supply 131, light source 132, aperture 133 and optics 136 to create an aiming light pattern projected on or near the target which spans a portion of the receive optical system 150 operational field of view with the intent of assisting the operator to properly aim the scanner at the bar code pattern that is to be read. A number of representative generated aiming patterns are possible and not limited to any particular pattern or type of pattern, such as any combination of rectilinear, linear, circular, elliptical, etc. figures, whether continuous or discontinuous, i.e., defined by sets of discrete dots, dashes and the like.

Generally, the aiming light source(s) 132 may comprise any light source to provide a desired illumination pattern at the target and may be one or more LEDs 134.

The light beam from the LEDs 132 may be directed towards an aperture 133 located in close proximity to the LEDs. An image of this back illuminated aperture 133 may then be projected out towards the target location with a lens 136. Lens 136 may be a spherically symmetric lens, an aspheric lens, a cylindrical lens or an anamorphic lens with two different radii of curvature on their orthogonal lens axis.

Alternately, the aimer pattern generator may be a laser pattern generator. The light sources 132 may also be comprised of one or more laser diodes wherein a laser collimation lens (not shown) will focus the laser light to a spot generally forward of the reader and approximately at the plane of the target T. This beam may then be imaged through a diffractive interference pattern generating element, such as a holographic element fabricated with a desired pattern.

Image reader may include an illumination assembly 142 for illuminating target area T. Illumination assembly 142 may also include one or more power supplies 144, illumination sources 146 and illumination optics 148.

Image sensor 154 may be a two dimensional array of pixels adapted to operate in a global shutter or full frame operating mode which is a color or monochrome 2D CCD, CMOS, NMOS, PMOS, CID, CMD, etc. solid state image sensor. The image sensor may contain an array of light sensitive photodiodes (or pixels) that convert incident light energy into electric charge. Solid state image sensors allow regions of a full frame of image data to be addressed.

An exemplary sensor 154 may be a back-illuminated sensor. In a back-illuminated back-illuminated image sensor an incident light beam is irradiated to the back face of a chip opposite to the other face or surface of the chip on which electrodes and the like are disposed. The back-illuminated back-illuminated image sensor is provided with a light converting portion for each pixel on the back face side of the chip, and it is provided with portions for processing signal charges (charge processing portions) in some way, such as an A/D converter and a signal storage portion on the surface side of the chip. If visible light is the incident beam, the pixels are photoelectric cells or photodiodes. The pixels may be arranged in a one or two-dimensional array, wherein the pixels may be adapted to operate in a rolling shutter, global shutter or full frame operating mode which is a color, monochrome or monocolor 2D CCD, CMOS, NMOS, PMOS, CID, CMD, etc. solid state back-illuminated image sensor. This sensor contains an array of light sensitive photodiodes (or pixels) that convert incident light energy into electric charge. Solid state back-illuminated image sensors allow regions of a full frame of image data to be addressed.

In a full frame (or global) shutter operating mode, the entire imager is reset before integration to remove any residual signal in the photodiodes. The photodiodes (pixels) then accumulate charge for some period of time (exposure period), with the light collection starting and ending at about the same time for all pixels. At the end of the integration period (time during which light is collected), all charges are simultaneously transferred to light shielded areas of the sensor. The light shield prevents further accumulation of charge during the readout process. The signals are then shifted out of the light shielded areas of the sensor and read out.

The output of the image sensor may be processed utilizing one or more functions or algorithms to condition the signal appropriately for use in further processing downstream, including being digitized to provide a digitized image of target T.

Microcontroller 160, may perform a number of functions, such as controlling the amount of illumination provided by illumination source 146 by controlling the output power provided by illumination source power supply 144. Microcontroller 160 may also control other functions and devices. It may include configurable blocks of analog and digital logic, as well as programmable interconnects. Microcontroller 160 may include a predetermined amount of memory 162 for storing data.

The components in reader 112 may be connected by one or more bus 168 or data lines that provides a communications link between integrated circuits in a system. This bus may connect to a host computer in relatively close proximity, on or off the same printed circuit board as used by the imaging device and may be used to link such diverse components as the image sensor 154, temperature sensors, voltage level translators, EEPROMs, general-purpose I/O, A/D and D/A converters, CODECs, and microprocessors/microcontrollers.

The functional operation of the host processor 118 involves the performance of a number of related steps, the particulars of which may be determined by or based upon certain parameters stored in memory 166 which may be any one of a number of memory types such as RAM, ROM, EEPROM, etc. In addition some memory functions may be stored in memory 162 provided as part of the microcontroller 160. One of the functions of the host processor 118 may be to decode machine readable symbology provided within the target or captured image. One dimensional symbologies may include very large to ultra-small, Code 128, Interleaved 2 of 5, Codabar, Code 93, Code 11, Code 39, UPC, EAN, and MSI. Stacked 1D symbologies may include PDF, Code 16K and Code 49. 2D symbologies may include Aztec, Datamatrix, Maxicode, and QR-code.

Decoding is a term used to describe the interpretation of a machine readable code contained in an image projected on the image sensor 154. The code has data or information encoded therein. Information respecting various reference decode algorithm is available from various published standards, such as by the International Standards Organization (“ISO”).

Operation of the decoding, which may be executed in a user or factory selectable relationship to a scanning routine, may be governed by parameters which are enabled for processing as a part of an autodiscrimination process, whether decoding is to be continuous or discontinuous, etc. Permitted combinations of scanning and decoding parameters together define the scanning-decoding relationships or modes which the reader will use. In the continuous mode (also referred to as continuous scanning mode, continuous streaming mode, streaming mode, fly-by scanning mode, on the fly scanning mode or presentation mode) the reader is held in a stationary manner and targets (such as symbols located on packages) are passed by the reader 112. In the continuous mode, the reader takes continuous image exposures seriatim and continuously decodes or attempts to decode some or all of these images. In the continuous mode exposure times and decoding times may be limited.

Discontinuous mode is a mode wherein scanning and/or decoding stops or is interrupted and initiated with an actuation event, such as pulling of a trigger 115, to restart. An exemplary utilization of the reader in discontinuous mode is via hand held operation. While triggered, the image reader may expose images continuously and decode images continuously. Decoding stops once the image reader is no longer triggered. Exposing of images however, may continue. In the discontinuous mode, the exposure time, decoding time out limits and decoding aggressiveness may be increased more than those set for continuous mode. The discontinuous mode is typically initiated because the operator knows a symbol is present. The decoder therefore may forego making a determination of the presence of a symbol because a symbol is presumed to be in the field of view. Discontinuous mode may provide longer range scanning than the continuous mode.

Switching between continuous and discontinuous modes may be accomplished by use of a trigger 115 located on the reader. For example, when the trigger is depressed by an operator the reader may operate in a discontinuous mode and when the trigger is released the reader may switch to continuous mode after a predetermined period of time. A scanning subroutine may specify an address buffer space or spaces in which scan data is stored and whether scanning is to be continuous or discontinuous. Another example of switching between continuous and discontinuous modes may be accomplished by symbology wherein switching between the modes depends on the type of symbology detected. The reader may stop attempting to decode a symbol after a predetermined time limit. The reader may limit the type of symbols to decode when in the continuous mode.

The aiming pattern generator may be programmed to operate in either continuous or discontinuous modes.

In the continuous mode, the reader may be configured to automatically switch to a reduced power state if no symbol has been sensed for a period of time. Upon sensing of a symbol the scanner may then automatically switch back to the higher power state continuous mode. In this reduced power state the scanner may change from having the aimer and/or illumination light sources on for every scan to having either/or on for only some of the scans (e.g. every 2 or 3 or less scans). In this manner the system may still be in a position to sense the presence of a symbol, but will draw less current and also generate less internal heating. After sensing a symbol, the image reader may utilize aiming/illumination for every scan until another period of inactivity is sensed.

Mode changes may be accomplished by the host computer in response to an appropriate signal over either a direct connection or wireless connection to the scanner.

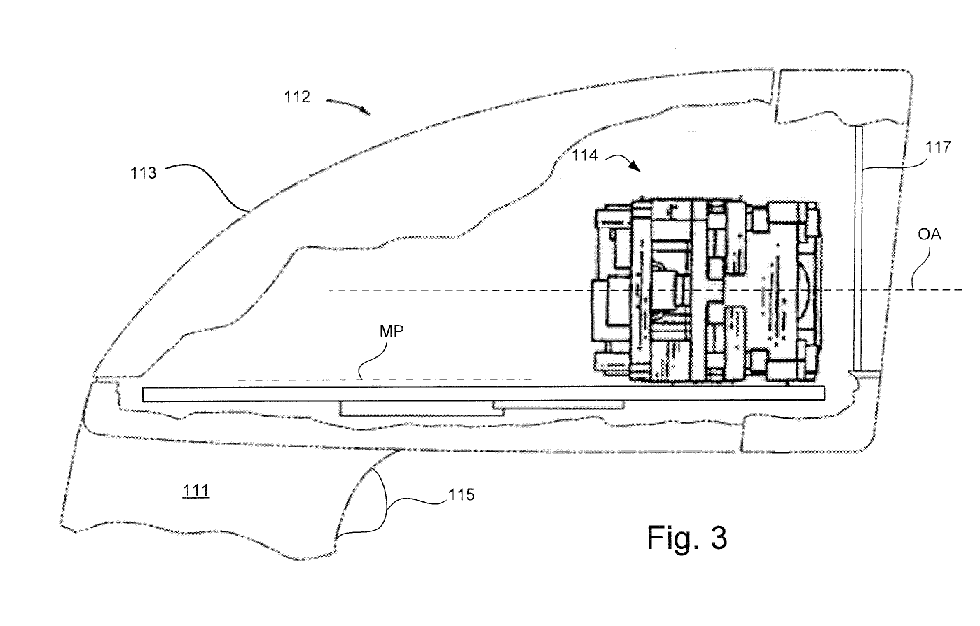

Referring to FIG. 3, an exemplary indicia reader 112 includes an imaging assembly 114 packaged in a housing 113 having a transparent window 117 provided therein to cover the aperture through which the imaging assembly transmits and receives light to scan or image a target. The window is integrated into the indicia reader package and is disposed between the image sensor and the target. The window may become dirty with contaminants such as dust, dirt or grease or it may become scratched. Imaging or scanning performance is diminished when this happens, although the operator may not be aware of the condition, or about the need to clean or replace the window.

At manufacturing, or during times when the indicia reader is idle, the indicia reader may establish a baseline image sensor output signal. The baseline signal may be obtained by scanning a black target that doesn't reflect light back to the reader or scanning without any objects being within scanning range so that the baseline signal doesn't contain light reflected from targets in front of the window. This baseline signal may be stored in memory as a relative “clean window” state. As the reader is used it may compare this relative idle baseline signal with later imager output signals. In an exemplary embodiment, the reader monitors fixed pattern noise and notifies an operator when the reader detects a predetermined level of fixed pattern noise that may indicate the window is contaminated. The imager output analog or digital signal may be used for comparing with a baseline signal and/or monitoring certain image sensor output signal parameters (such as fixed noise patterns) to determine if the window is contaminated. The reader may notify the operator of the dirty window condition. This feedback may be by an indicator light, an audible sound or notification on a display.

The baseline “calibration” signal may be established periodically, or after the window is cleaned or replaced. The imager output signals may be monitored or and/or compared when every image is taken, periodically at predetermined intervals, continuously, or when the indicia reader is in an idle state or not in use. Imager output signals may be accumulated or collected over a period and an average or median signal may be calculated with these collected signals for determination of whether the window is contaminated and the level of contamination.

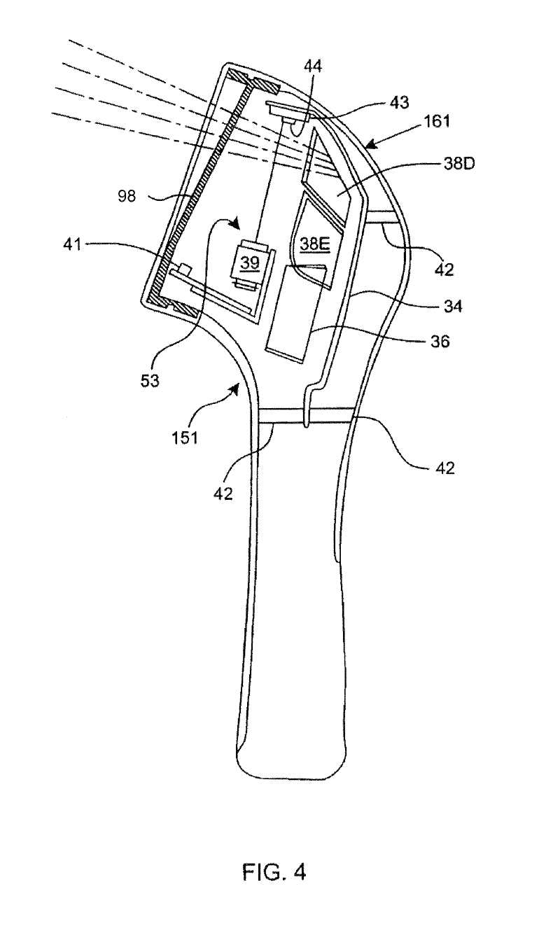

FIG. 4 illustrates an exemplary laser scanning platform 151 that employs a mechanism that controls the duty cycle of a laser light source (e.g., laser diode) to selectively produce an omni-directional scan pattern or the single line scan pattern. The laser scanning platform 53 comprises an assembly of subcomponents assembled upon an optical bench 34 with respect to a central longitudinal reference plane 35. The optical bench is mounted to the housing 161 of the device 151 by posts 42. This subcomponent assembly includes a scanning polygon 36 having light reflective surfaces (e.g., facets) each disposed at a tilt angle with respect to a rotational axis of the polygon. An electrical motor is mounted on the optical bench 34 and has a rotatable shaft on which polygon 36 is mounted for rotation therewith. An array of stationary mirrors (e.g. 38D and 38E) are fixedly mounted with supports (not shown) to the optical bench 34 at twist and bend angles.

A laser beam production module 39 is fixedly mounted above the rotating polygon 36 with supports (not shown) and produces a laser beam having a circularized beam cross-section and essentially free of astigmatism along its length of propagation. The laser beam production module 39 may be realized in a variety of ways. Preferably, it comprises a visible laser diode for producing a visible laser beam, and associated optics for circularizing the laser beam and eliminating astigmatism therefrom along its direction of propagation. For example, the associated optics may include an aspheric collimating lens, a beam circularizing prism, and a holographic light diffractive grating configured in such a manner that the above-described functions are realized during laser beam production.

In the omni-directional scan mode of operation, the duty cycle of the laser light source of the laser beam production module is controlled so that the laser beam is continuously produced therefrom and directed to rotating polygon 36, which cooperates with the array of stationary mirrors (e.g. 38D and 38E) to produce an omni-directional scan pattern that passes through transmission window 98.

In the unidirectional (single scan line) scan mode of operation, the duty cycle of the laser light source of the laser beam production module is controlled so that the laser beam is produced therefrom only during those intervals when the laser beam (as redirected by the rotating polygon 36) strikes a central stationary mirror, thereby producing a unidirectional single line scan pattern that passes through transmission window 98.

An analog signal processing board 40 is fixedly mounted over the rotating polygon 36 with supports (not shown), and carries one or more photodetector 41 (e.g., silicon photosensor(s)) that detects reflected laser light and produces analog scan data signals in addition to analog signal processing control circuits 42 (not shown) for performing various functions, including analog scan data signal processing. In addition, the analog signal processing board 40 preferably includes visible laser diode drive circuitry (not shown), motor drive circuitry (not shown), object sensing circuitry (e.g., an infra-red light source, such as an infra-red LED, associated drive circuitry, and infra-red light detection circuitry) and associated object detect circuitry, the functions of which are described in greater detail hereinafter.

A light collecting mirror 43 is disposed at a height above a central stationary mirror and collects returning light rays reflected off the rotating polygon 36 and focuses the same onto the photodetector 41. A beam directing surface 44, realized as a flat mirror mounted on the light collecting mirror 43, directs the laser beam from the laser beam production module 39 to the rotating polygon 36.

The unidirectional (single scan line) scan mode of operation requires that the duty cycle (on/off cycle) of the laser light source of the laser beam production module 39 be synchronized to the particular interval in the rotation cycle of the rotating polygon 36 wherein the rotating polygon 36 directs the scanning laser beam to the central stationary mirror.

The transmission window 98 may become dirty with contaminants such as dust, dirt or grease or it may become scratched. Imaging or scanning performance is diminished when this happens, although the operator may not be aware of the condition, or about the need to clean or replace the window.

At manufacturing, or during times when the indicia reader is idle, the indicia reader may establish a baseline photodetector output signal. The baseline signal may be obtained by scanning a black target that doesn't reflect light back to the reader or scanning without any objects being within scanning range so that the baseline signal doesn't contain light reflected from targets in front of the window. This baseline signal may be stored in memory as a relative “clean window” state. As the reader is used it may compare this relative idle baseline signal with later imager output signals. In an exemplary embodiment, the reader monitors fixed pattern noise and notifies an operator when the reader detects a predetermined level of fixed pattern noise that may indicate the window is contaminated. The photodetector output analog or digital signal may be used for comparing with a baseline signal and/or monitoring certain image sensor output signal parameters (such as fixed noise patterns) to determine if the window is contaminated. The reader may notify the operator of the dirty window condition. This feedback may be by an indicator light, an audible sound or notification on a display.

The baseline “calibration” signal may be established periodically, or after the window is cleaned or replaced. The photodetector output signals may be monitored or and/or compared when every scan is taken, periodically at predetermined intervals, continuously, or when the scanner is in an idle state or not in use. Scanner output signals may be accumulated or collected over a period and an average or median signal may be calculated with these collected signals for determination of whether the window is contaminated and the level of contamination.

An exemplary flowchart is provided in FIG. 4, wherein a baseline signal is acquired in a step 210 and stored in a step 212. A target is scanned in a step 214. and the scanned signal is compared to the baseline signal in a step 218. A query is made in a step 222 if the scanned signal indicates window contamination. If yes, then the operator is notified about the window contamination in a step 226. If no, then another scan is taken.

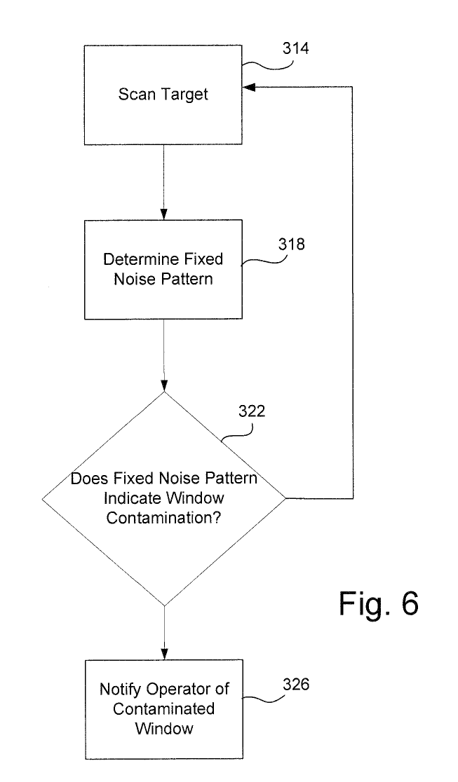

An exemplary flowchart is provided in FIG. 6, wherein a target is scanned in a step 314. The fixed noise pattern of the scan is determined in a step 318. A query is made in a step 322 if the fixed noise pattern indicates window contamination. If yes, then the operator is notified about the window contamination in a step 326. If no, then another scan is taken.

An exemplary embodiment described herein is a method of operating an indicia reader comprising the steps of: transmitting light onto a target; receiving light from the target through a protective window and directing the light through receive optics to an image sensor; converting the received light into image output signals representative thereof with the image sensor; storing a baseline image output signal derived from a calibration target; decoding indicia information within targets containing information bearing indicia derived from the output signals; comparing image output signals with the baseline image output signal; and, notifying an operator when the comparison indicates the protective window is contaminated with an audible or visual signal.

Another exemplary embodiment described herein is a method of operating an indicia reader comprising the steps of: transmitting light onto a target; receiving light from the target through a protective window and directing the light through receive optics to an image sensor; converting the received light into image output signals representative thereof with the image sensor; storing a baseline image output signal derived from a calibration target; decoding indicia information within targets containing information bearing indicia derived from the output signals; monitoring the image output signals for fixed pattern noise; and, notifying an operator when a predetermined level of fixed pattern noise is detected.

It should be understood that the programs, processes, methods and apparatus described herein are not related or limited to any particular type of computer or network apparatus (hardware or software). Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa. The illustrated embodiments are exemplary only, and should not be taken as limiting the scope of the present invention. For example, the steps of the flow diagrams may be taken in sequences other than those described, and more, fewer or other elements may be used in the block diagrams. Also, unless applicants have expressly disavowed any subject matter within this application, no particular embodiment or subject matter is considered to be disavowed herein.

1. A method of operating an indicia reader comprising the steps of:
transmitting light partly through a window toward a target;
receiving reflected light from the target and the window onto a photodetector;
converting the received light into photodetector output signals representative thereof with the photodetector;
storing a baseline photodetector output signal derived solely from light reflected from the window;
decoding indicia information within the target containing information bearing indicia derived from the photodetector output signals;
comparing photodetector output signals with the baseline photodetector output signal; and,
notifying an operator with an audible or visual signal when the comparison indicates the window is contaminated.

2. A method of operating an indicia reader in accordance with claim 1, wherein the comparing step occurs continuously, or at predetermined intervals, or when the indicia reader is in an idle state.

3. A method of operating an indicia reader in accordance with claim 1, wherein the comparing step comprises collecting photodetector output signals over a period and calculating an average signal.

4. A method of operating an indicia reader in accordance with claim 1, wherein the storing a baseline signal step comprises transmitting and receiving light without light reflected a target.

5. A method of operating an indicia reader in accordance with claim 1, wherein the comparing step comprises calculating a fixed pattern noise.

6. A method of operating an indicia reader comprising the steps of:
transmitting light onto a target;
receiving light from the target through a protective window with a photodetector;
converting the received light into photodetector output signals representative thereof with the photodetector;
decoding indicia information within targets containing information bearing indicia derived from the photodetector output signals;
storing a baseline photodetector output signal derived from transmitting, receiving and converting with no light reflected from a target;
monitoring the photodetector output signals for fixed pattern noise; and,
notifying an operator when a predetermined level of fixed pattern noise is detected.

7. A method of operating an indicia reader in accordance with claim 6, further comprising comparing the fixed pattern noise with the baseline photodetector output signal.

8. A method of operating an indicia reader in accordance with claim 6, wherein the monitoring step occurs continuously, or at predetermined intervals, or when the indicia reader is in an idle state.

9. A method of operating an indicia reader in accordance with claim 6, wherein the monitoring step comprises collecting photodetector output signals over a period and calculating an average signal.

10. A method of operating an indicia reader in accordance with claim 6, wherein the storing a baseline signal step comprises placing a calibration target in front of the window.

11. An indicia reader comprising:
transmitting light onto a target;
receiving light from the target through a protective window with a photodetector;
converting the received light into photodetector output signals representative thereof with the photodetector;
memory for storing a baseline photodetector output signal derived with no light reflected from a target; and,
a processor for:
decoding indicia information within targets containing information bearing indicia derived from the photodetector output signals;
comparing photodetector output signals with the baseline photodetector output signal;
notifying an operator with an audible or visual signal when the comparison indicates the window is contaminated.

12. An indicia reader in accordance with claim 11, wherein comparing occurs continuously, or at predetermined intervals, or when the indicia reader is in an idle state.

13. An indicia reader in accordance with claim 11, wherein comparing comprises collecting photodetector output signals over a period and calculating an average signal.

14. An indicia reader in accordance with claim 11, wherein storing a baseline signal comprises placing a calibration target in front of the indicia reader window.

15. An indicia reader in accordance with claim 11, wherein comparing comprises calculating a fixed pattern noise.

16. An indicia reader comprising:
a light source for transmitting light onto a target;
a photodetector for converting reflected light source light into photodetector output signals representative thereof;
a window disposed between the photodetector and the target;
memory for storing a baseline photodetector output signal derived from a calibration target; and,
a processor for:
decoding indicia information within targets containing information bearing indicia derived from photodetector output signals;
monitoring the photodetector output signals for fixed pattern noise; and,
notifying an operator with an audible or visual signal when the monitoring indicates the window is contaminated.

17. An indicia reader in accordance with claim 16, wherein the processor compares the fixed pattern noise with the baseline photodetector output signal.

18. An indicia reader in accordance with claim 16, wherein monitoring occurs continuously, or at predetermined intervals, or when the indicia reader is in an idle state.

19. An indicia reader in accordance with claim 16, wherein monitoring comprises collecting photodetector output signals over a period and calculating an average signal.

20. An indicia reader in accordance with claim 16, wherein storing a baseline signal step comprises placing a calibration target in front of the window.
